(19) United States
(12) Patent Application Publication
(10) Pub. No.: US 2009/0210307 A1
(43) Pub. Date: Aug. 20, 2009

(54) METHOD AND SYSTEM FOR PROMOTING SERVICE PROVIDERS

(76) Inventors: David Bruce Plunkett, Laingholm (NZ); Linda Seto, Laingholm (NZ)

Correspondence Address: JEFFER, MANGELS, BUTLER & MARMARO, LLP, 1900 AVENUE OF THE STARS, 7TH FLOOR, LOS ANGELES, CA, 90067, US

(21) Appl. No.: 12/305,086

(22) PCT Filed: Jun. 18, 2007
(86) PCT No.: PCT/NZ07/00161

§ 371 Date: Feb. 9, 2009

(30) Foreign Application Priority Data
Jun. 19, 2006 (NZ) 547380
Aug. 11, 2006 (NZ) 549152

(51) Int. Cl. G06Q 30/00; G06Q 10/00; G06Q 50/00

(52) U.S. Cl. 705/14; 705/10; 705/26; 705/34

(57) ABSTRACT

The present invention relates to a set of computer executable instructions and preferably an apparatus employed to promote at least one service provider. The invention operates to initially present a plurality of service provider listings to a user. The user selects and employs a service provider and then subsequently supplies a service provider review. This service provider review is employed to update the associated service provider listing of the service provider employed.

### TECHNICAL FIELD

This invention relates to a method, system and preferably an apparatus configured to promote service providers. In a preferred embodiment the present invention may be employed to implement an internet portal interface which can allow a number of service provider listings to be presented to a potential user. Preferably such an interface may also allow a user to update such listing information with performance feedback information once they have employed the services of a particular service provider.

### BACKGROUND ART

Finding a reputable tradesperson or a potential employee who can perform effectively can be difficult and time consuming task.

In large metropolitan centres a significant number of tradespersons are active and advertise their services in business or telephone directories. Generally speaking for employers the only reliable form of performance feedback for such trades people is through word of mouth, depending on the people they know who have previously employed the trades people involved.

This situation generally favours trades people who have been operating in a particular geographical region for some time and have provided an adequate level of service. It does not necessarily allow prospective employers to find high quality or best performing trades people easily or quickly unless these people come highly recommended by word of mouth.

It would therefore be preferable to have an improved system, method or apparatus able to address any or all of the above current limitations with selecting service providers such as trades people. In particular it would be preferable to have provided an internet technology based portal system which could present listing information relating to a range of possible service providers which would allow a user to obtain prior performance information in relation to a particular service provider. In particular it would be of advantage to have feedback available with respect to a service provider's prior performance of one or more performed tasks.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there are provided computer executable instructions adapted to facilitate a method of promoting at least one service provider, said computer executable instructions being adapted to execute the steps of:
i) presenting a plurality of service provider listings to a user, and
ii) receiving a service provider review from the user once a service provider has been employed, and
iii) updating the associated service provider listing for the service provider review received.

According to a further aspect of the present invention there are provided computer executable instructions adapted to facilitate a method of promoting at least one service provider, said computer executable instructions being adapted to execute the steps of:
i) presenting a plurality of service provider listings to a user, and
ii) receiving a job request from the user, said job request identifying a task to be completed and identifying a service provider associated with one or more of the listings presented, and
iii) transmitting a job notification to the service provider identified in the received job request, and
iv) receiving a service provider review from the user, and
v) updating the service provider listing of the service provider associated with the received service provider review.

According to a further aspect of the present invention there is provided computer executable instructions substantially as described above, further characterised by the additional subsequent step of receiving a user review from the service provider employed and updating a user listing for the user associated with said received user review.

According to yet another aspect of the present invention there are provided computer executable instructions adapted to facilitate a method of promoting at least one service provider, said computer executable instructions being adapted to execute the steps of:
i) presenting a plurality of service provider listings to a user, and
ii) receiving a job request from the user, said job request identifying a task to be completed and identifying a service provider associated with one or more of the listings presented, and
iii) transmitting a job notification to the service provider identified in the received job request, and
iv) receiving a user review from a service provider, and
v) updating a user listing for a user associated with the received user review.

According to yet another aspect of the present invention there is provided computer executable instructions adapted to facilitate a method of promoting at least one service provider, said computer executable instructions being adapted to execute the steps of:
i) presenting a plurality of service provider listings to a user, and
ii) receiving a job request from the user, said job request identifying a task to be completed and identifying a service provider associated with one or more of the listings presented, and
iii) transmitting a job notification to the service provider identified in the said received job request, and
iv) receiving a service provider review and a user review, and
v) updating the service provider listing and a user listing associated with each of the received service provider and user reviews received.

According to a further aspect of the present invention there is provided a service provider promotion apparatus which includes,

a service provider listing presentation module configured to present service provider listings to a user, and
a service provider review reception module configured to receive said provider reviews from a user, and
a service provider listing update module, wherein said module updates a service provider listing with a received service provider review associated with said service provider listing.

The present invention is adapted to provide a method system and preferably an apparatus for promoting service providers. In a preferred embodiment the present invention may be implemented using computer and internet based technology, to allow the promotion of service providers to users with computers, internet connections and web page browsers.

In a preferred embodiment the present invention may be used to provide or implement an internet based portal interface through web server architecture. A user's web browser applications may receive information from and transmit information to such a web server to provide a method of promoting service providers formatted in accordance with the present invention. In such embodiments the executable instructions of the present invention can be implemented via a client/server architecture using a client web browser and web server. Those skilled in the art should appreciate that the instructions to be executed may be divided between both the client and server in such embodiments.

In a further preferred embodiment the present invention may also employ a thick client architecture where custom user software is distributed to and employed by users, preferably from an installation CD or DVD. Such optical media can be distributed from a retail point of sale with its packaging also incorporating an authorisation key to provide proof of purchase and allows a user to register to use the methodology of the present invention.

However, those skilled in the art should appreciate that such thick client software may be distributed by other channels, such as for example, direct downloads by users. Furthermore, some limited functionality of the system provided by the present invention may also be employed by users who do not have an authorisation key or are not registered users.

Such a thick client software implementation may provide a number of the local computer functions or facilities discussed below, and may also facilitate the organisation and storage of additional information content unique to each user. Such thick client software may also communicate with a remote web server to receive or transmit information in accordance with the methodology of the present invention.

In general terms reference throughout this specification will be made to users employing a standard web browser to communicate with such a web server. However, those skilled in the art should appreciate that other types of browser client which facilitate extended functionality may also be used in conjunction with the present invention.

Reference in general terms throughout this specification will also be made to the present invention being implemented through computer executable instructions which are programmed into and executed by web server and client browser computer systems. These instructions may facilitate the provision of a method of promoting service providers, while the computer systems may provide a service provider promotion apparatus required in accordance with the present invention. Those skilled in the art should appreciate that such a service provider promotion apparatus may be implemented through a number of computer executable code modules which can provide or extend the functionality of the apparatus to be implemented.

In general terms reference throughout this specification will now be made to the present invention being implemented through specific software programmed into a web server computer systems, but those skilled in the art should appreciate that other types of technical hardware or computer system architectures may also be employed in conjunction with the present invention if required.

For example, those skilled in the art should also appreciate that the present invention may extend to the software or code used to provide a user focused thick client application discussed above. Such client software may communicate with the web server involved and also allow for the local performance of a number of functions or facilities.

In addition, in one alternative embodiment the system or apparatus of the present invention may be provided through an information kiosk located in a public area.

The present invention may be used to promote a plurality of service providers. Service providers, as promoted in accordance with the present invention may consist of individuals looking for employment, sole operator trades people looking for clients, professional service workers such as accountants and lawyers and so forth, through to organisations of such individual service providers again looking for work or new clients. Furthermore the terms under which services rendered by such service providers may range from casual one-off tasks, fixed term contract work, through to short-term employment positions for example. Those skilled in the art should also appreciate that there should be no limit on the types of service offered by service providers—which may range from, for example, the provision of accommodation, travel services, teaching of tuition and so forth.

Reference however will be made throughout this specification to the service providers involved being trades people looking for individual jobs or tasks to complete for clients or users. However as discussed above those skilled in the art should appreciate that other types of service providers and organisations consisting of service providers may also be promoted in accordance with the present invention.

In addition, references made to users throughout this specification should be taken in a preferred embodiment to indicate registered users of the facilities implemented. In such embodiments only authorised persons who have purchased an authorisation key or password may be allowed to fully participate in the methodology provided in accordance with the present invention. For example, in one preferred embodiment any such registered users may be given the ability to transmit job requests or service provider reviews used in conjunction with the present invention.

However, those skilled in the art should appreciate that other non-registered users may also employ some components to the functionality offered in accordance with the present invention. For example, in some instances being a registered user may provide the ability to access a top tier of functions which may not necessarily be essential to the basic promotion of a service provider.

Furthermore, reference throughout this specification will also be made to a user of the promotion service implemented being a prospective employer or client of the service provider. As discussed above preferably such users may employ internet or web browsers to access an internet portal facility which promotes such service providers. Again however, those skilled in the art should appreciate that such users may also incorporate members of regulatory bodies wishing to keep tabs on the performance of selected service providers, potential investors into service provider organisations or any other entities which may have a use for the information presented in accordance with the present invention.

Preferably the internet portal provided may promote particular service providers through presenting a plurality of service provider listings to enquiring users. Such service provider listings may give information with respect to the services and terms of employment offered by a particular service provider, potentially in combination with advertising style information. Furthermore, such service provider listings preferably also include prior performance feedback information for a particular service provider which has been given by prior users or employers of that particular service provider. Such information may relate to the service provider's performance at a task previously assigned to them. Such prior performance feedback may in turn be incorporated into a service provider listing and displayed to the users in their selection of a particular service provider for a task they wish to have completed.

In one alternative embodiment a service provider listing may include direct contact information for a particular service provider. A user may employ this information to contact the service provider directly and commission them to perform a particular task or service. In such instances users may return to the internet portal or site to supply a service provider review. Such service provider reviews may again be integrated into or form part of the service provider listing for the service provider.

In such instances the terms and conditions of use of the internet portal provided may require users to return to the portal to supply a service provider review, and to also advise the operator of the invention that a particular service provider has been hired. However, in a preferred embodiment communications between the service provider and a user may be channeled through the internet portal. In such instances the internet portal may act as an interface to receive job requests from a user which identify a particular task to be completed and also identify a particular service provider nominated for this task. In such an embodiment the internet portal may then despatch a job notification to the identified service provider where this notification identifies the task to be completed and the user who has requested help. Such job requests and job notifications may allow the system and apparatus of the present invention to track which users have employed which service providers and to in turn prompt users and service providers for feedback information.

In a preferred embodiment the completion or transmission of such job requests and job notifications by users and service providers will constitute the acceptance of a contractual agreement by both parties in relation to the particular task. The present invention may be employed to form a contract between a user and service provider, preferably to form an agreement between both parties which is valid for a set period of time (such as for example, seven days). Furthermore, such a contractual arrangement between a user and service provider may also be essential or required by the terms and conditions of use of the internet portal to in turn allow a user to provide a service provider review after the completion of the task they have contracted a service provider to perform.

In a preferred embodiment the web server provided may be configured to receive a service provider review from a user. Such service provider reviews may be specific to a particular task assigned to a service provider and may give feedback on how well the service provider performed the task. Such service provider reviews may incorporate qualitative information such as the timeliness under which the service was rendered and whether the service provider was early or late for the job, or whether the job was finished early or late. Such reviews may also include quantitative information such as cost or potentially identify quality issues present within the work completed.

Such service provider reviews may act as an information source to update service provider listings once a particular service provider has been employed by a user. Preferably a service provider listing may grow over time as the service provider completes a number of tasks and receives performance feedback from their employers in relation to each of these tasks.

In some embodiments the present invention may also be adapted to present a plurality of user listings which may be viewed by service providers. Such user listings may give information pertinent to service providers debating whether to accept a job or contract from particular users. For example, in some instances such user listings may provide information submitted by a number of service providers with respect to tasks which have previously been completed for the identified user. Furthermore, such user listings may also include prior performance information submitted by service providers regarding their experiences previously working for such users. Potentially such user reviews may give information with respect to a user's creditworthiness and ability to pay for services they have requested.

In a further embodiment the web server provided may also be configured to receive user reviews from service providers who have previously been employed by a user to perform a particular task. In some instances service providers may be prompted to submit user reviews after they have completed a particular task for a user. The information incorporated into a user review by a service provider may in turn be used to update prior performance feedback information presented within a user listing.

In a preferred embodiment the internet portal may also include a favourites service provider collection presentation system. In such embodiments the service provider promotion apparatus will include a favourites service provider module. For example, in a further preferred embodiment the internet portal may present a “favourites” service provider page to a user which consists of identifiers or service provider listings for service providers which the user involved is happy employing, or has previously employed and enjoyed good service from. Such a “favourites” web page may allow a user to quickly identify their preferred service provider for a task.

Those skilled in the art should also appreciate this type of “favourites” facility may also be implemented in other ways based on the particular architecture of the software or components employed. For example, in one instance a favourites facility may be provided locally via a thick client software application, where this thick client may maintain a local record or file of favourite service providers without necessarily requiring this information to be stored on or by a remote web server.

In a preferred embodiment the present invention may also provide or facilitate a quotation collection system for users. In such embodiments the service provider promotion apparatus provided will include a quotation collection module.

For example, in a further preferred embodiment a web server implementation of the invention may present a user with a “my quotations” web page. Such a web page may collate and display a list of current quotations received from one or more service providers with respect to one or more tasks a user wishes to have completed. Such a “my quotations” page may readily allow users to compare the services and prices on offer from particular service providers in relation to a single task. Alternatively this page may allow a user to easily manage a complex project which incorporates a number of tasks and requires input from a number of different service providers.

Those skilled in the art should also appreciate this type of “my quotations” facility may also be implemented in other ways based on the particular architecture of the software or components employed. For example, in one instance a my quote facility may be provided locally via a thick client software application, where this thick client may maintain a local record or file of quote information received without necessarily requiring this information to be stored on or by a remote web server.

In some embodiments the present invention may also present to service providers a job organiser facility. In such embodiments the service provider promotion apparatus provided will include a job organiser module. Such a job organiser module may collate or collect together information pertaining to particular tasks or jobs which the service provider has committed to completing. Preferably this module may also provide information with respect to when these tasks are to be completed, in addition to other optional information such as the location of the task, materials required to complete the task, or costing or quotation information previously given to the user or employer associated with a task.

For example, in some instances such a module may present web pages or other information capable of being displayed in a web browser to display such information.

Furthermore such a job organiser module may automatically be updated with new tasks once job requests are received from users, and may also automatically delete jobs from the job organiser module once service provider reviews are received from users when an associated task has been completed. In such embodiments the apparatus provided may modify the information presented by the job organiser module depending on status information communicated to it by both users and service providers. For example, if a user transmits a job request, this will trigger the creation of a job specific entry within the job organiser module. Corresponding messages may subsequently be transmitted to the apparatus of the present invention by either a user or service provider after a job has been completed to update the job organiser module and remove completed job entries.

Those skilled in the art should also appreciate this type of “job organiser” facility may also be implemented in other ways based on the particular architecture of the software or components employed. For example, in one instance a job organiser facility may be provided locally via a thick client software application, where this thick client may maintain a local record or file of current job information.

In some embodiments the internet portal may also manage accounts receivable and/or accounts payable subsystems for service providers or users. In such embodiments the service provider promotion apparatus will include an accounting information module. In effect the internet portal provided may manage credits or debits between these groups and allow users to keep a balance of their financial records and have an easy calculation system for tax purposes.

In some embodiments the present invention may implement or facilitate a payment holding or escrow service. In such embodiments the service provider promotion apparatus provided will include a payment holding escrow module. This allows the payment for services of the service provider to be paid in advance but held until the job, or a specific part of the job has been completed.

In some embodiments the escrow service may be included in, or associated with the accounts receivable and/or accounts payable subsystems in the internet portal.

However, in a preferred embodiment a user may access the escrow service for a particular service provider or a particular job through a link on the service provider's listing or via a job request.

The use of the escrow service may be optional, with some service providers utilising it, and others not. The details of the service provider may also indicate whether they allow users to make use of the escrow service.

In some embodiments the user may receive a job reference which can be used to identify a payment for a particular job. The job reference may also be used to track an escrow payment.

In a preferred embodiment the user may make a payment into the escrow service after they have obtained a quote from a service provider, but prior to the job being commenced. Depending on the job, the payment made may either be full payment for the quoted price, or a deposit of a stipulated amount.

In a preferred embodiment the escrow service may inform the service provider that a payment has been made, and/or has cleared for a particular job. The service provider may then commence the job. Preferably the service provider may be informed via an automatic email from the apparatus of the present invention.

In a preferred embodiment a payment may be released from the escrow service by the user once the job, or a stage of the job has been completed to an agreed standard. For example this may be via the user accessing the payment within the escrow service and advising or accepting that the job has been completed.

In a preferred embodiment the user may not remove the payment from the escrow service once made, unless there is agreement between both parties or a court decision. For example, a service provider may no longer be able to undertake the job in question; in this instance they would allow the payment to be returned to the user.

The escrow service provides security for the service provider, in that payment is made prior to a job being undertaken. The escrow service also provides security for the user, by ensuring that a job has been completed, or completed to a pre-agreed standard before payment is released to the service provider.

In some embodiments the present invention may also facilitate a data export and archive facility for service providers or users. In such embodiments the service provider promotion apparatus provided will include a data export module. In such instances service providers or users may export out information pertaining to their service provider listings or user listings to backups and store on computer media under the control of the service provider or user. Such a facility may be used when the data storage capacity of the web server may be limited, and warnings may be given to service providers or users that old information will be automatically deleted.

In some embodiments the present invention may also facilitate a data input function for service providers or users. In such instances a thick client software application may be run locally on a service provider's or user's computer system, where unique or personal information of the user or service provider may be imported directly into the thick client software involved. For example, in some embodiments this input facility may be used to store curriculum vitae information, service provider advertising material or other relevant information a user or service provider may wish to manage using the present invention, either locally or on their own computer system, or using the inventions remote web server.

The present invention may provide many potential advantages over the prior art.

The present invention may be used to provide a portal or interface facility between service providers and the users or employers of such service providers.

The present invention may handle communications between service providers and their users and also gather feedback with respect to each of these entities for publication to other users or service providers who may be considering employing or being employed by these groups.

The present invention may also provide an organisation or management facility for service providers, allowing them to organise their jobs which they have currently pending. Preferably such job organisation information may be automatically updated by the systems of the present invention when new jobs or tasks are assigned to a service provider or when the service provider has subsequently completed such tasks.

The present invention may also provide an information collection and management facility to users, allowing them to track their favourite service providers and also to collate and collect together costing or quotation information previously received from service providers.

### BRIEF DESCRIPTION OF DRAWINGS

Further aspects of the present invention will become apparent from the following description which is given by way of example only and with reference to the accompanying drawings in which:

FIGS. 1A, 1B shows a home web page and search facility provided in accordance with a preferred embodiment of the present invention, and

FIGS. 2, 3 show portions of a service provider listing linked to by a search results page illustrated in FIG. 1B, and

FIGS. 4, 5A & 5B show portions of a job request and job notification received and transmitted in accordance with a preferred embodiment, and

FIG. 6 shows a data entry page configured to collate and subsequently transmit a service provider review in a preferred embodiment, and

FIG. 7 shows a data entry page configured to collate and subsequently transmit a user review in a preferred embodiment, and

FIG. 8 shows portions of the updated service provider reviews illustrated with respect to FIG. 3 after a new service provider review has been received in accordance with a preferred embodiment, and

FIG. 9 shows a portion of a service provider listing wherein the service provider employs the escrow service or payment minder facility, and

FIG. 10 shows a portion of a data entry form for payment details from the user to the escrow service and which shows the terms and conditions of the escrow service or payment minder, and

FIGS. 11 and 12 show alternative versions of a job request and job notification when an escrow service is employed in conjunction with a service provider, and

FIGS. 13-17 provide a number of exemplary flowcharts of user and service provider interaction with the invention as implemented in one embodiment using an internet portal.

### BEST MODES FOR CARRYING OUT THE INVENTION

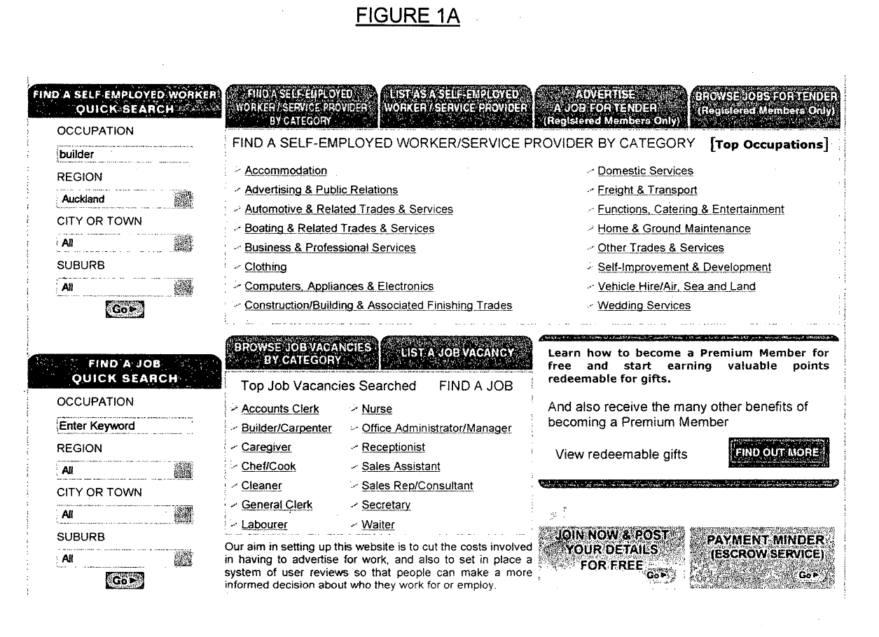

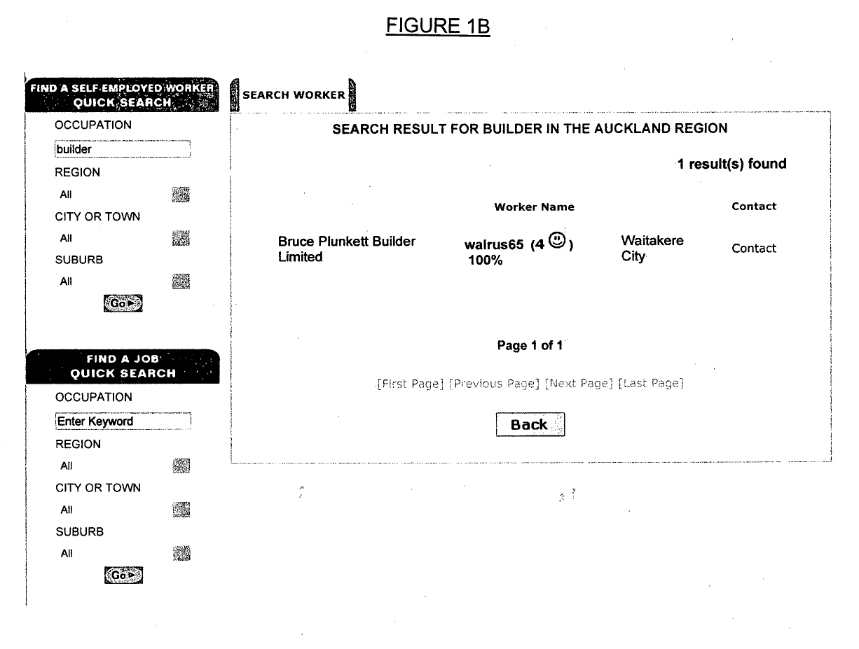

FIGS. 1A and 1B show a home web page and search facility provided in accordance with a preferred embodiment of the present invention.

FIG. 1A illustrates a home page and search interface provided in accordance with a preferred embodiment of the present invention when implemented as an internet web site portal. As can be seen from FIG. 1A drop down menus allow a search to be completed with respect to particular parameters associated with tradesmen service providers. Alternatively, a particular type or category of service providers may be selected from links presented in the top half of the page.

FIG. 1B illustrates a search results page generated through working with the search interface shown with respect to FIG. 1A. The search results page of FIG. 1B can present one or more service provider or tradesmen identifiers and links to further service provider listings for these trades people.

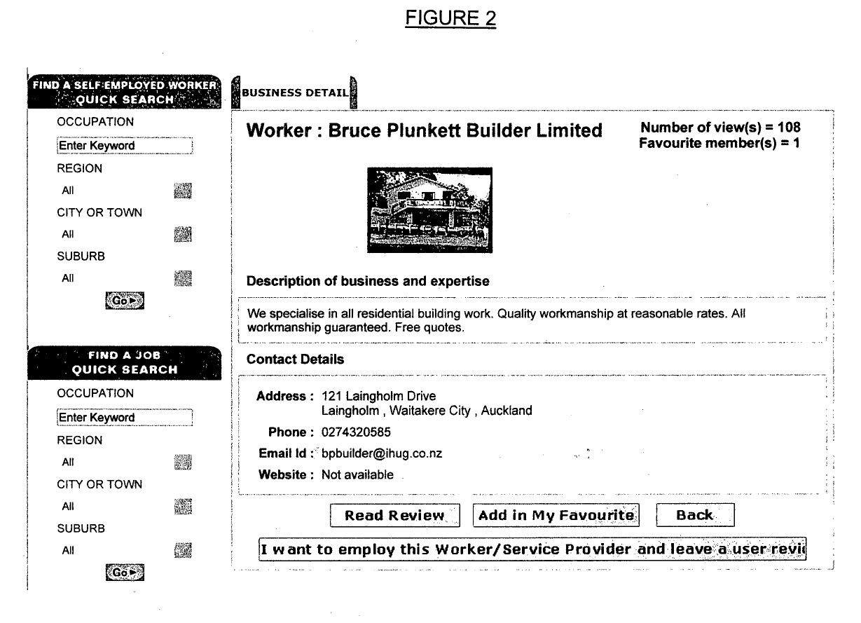

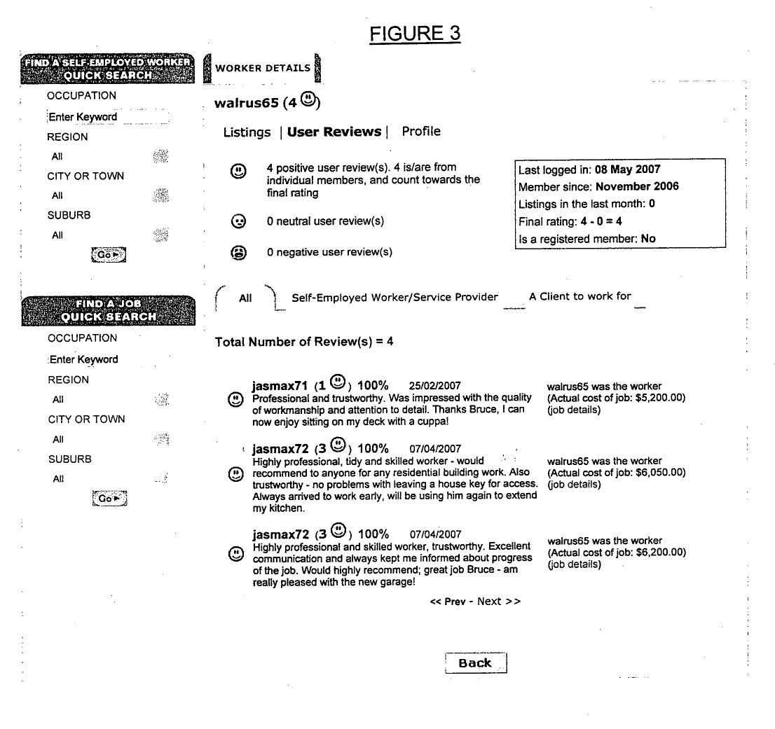

FIGS. 2 and 3 show portions of a service provider listing linked to by a search results page illustrated in FIG. 1B.

FIG. 2 illustrates a general descriptive and advertising material for a particular builder service provider, and also illustrates direct contact information for the builder service provider.

FIG. 3 illustrates more detail integrated into the service provider listing of this builder, including components of or content from a number of service provider reviews previously received from prior employers. Previous service provider reviews are received and incorporated into this portion of the builder's listing to reflect their prior performance with respect to a number of building related tasks.

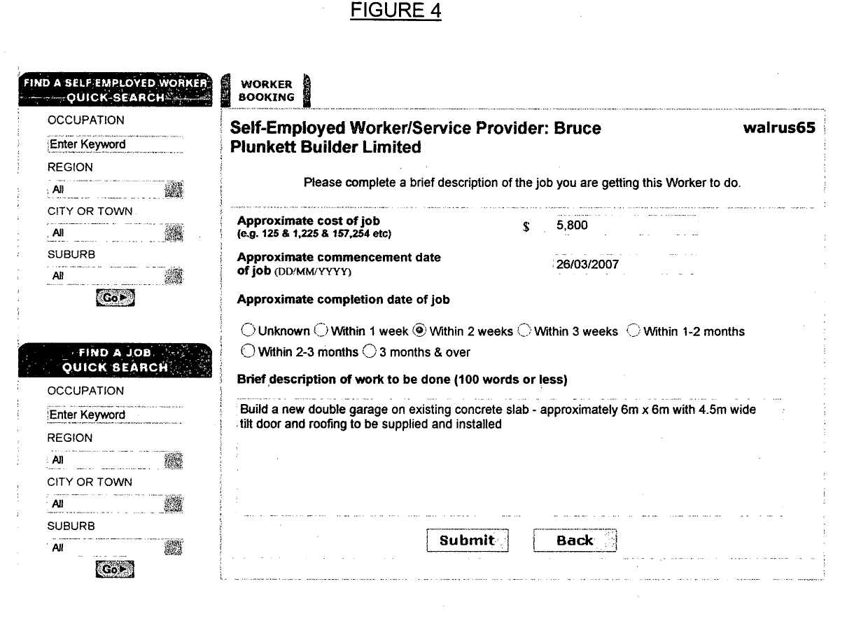

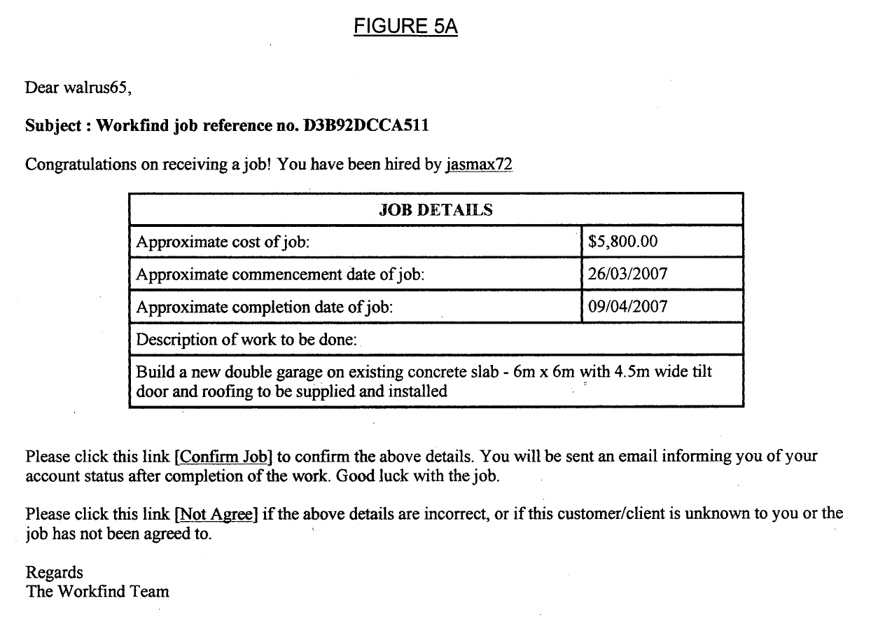

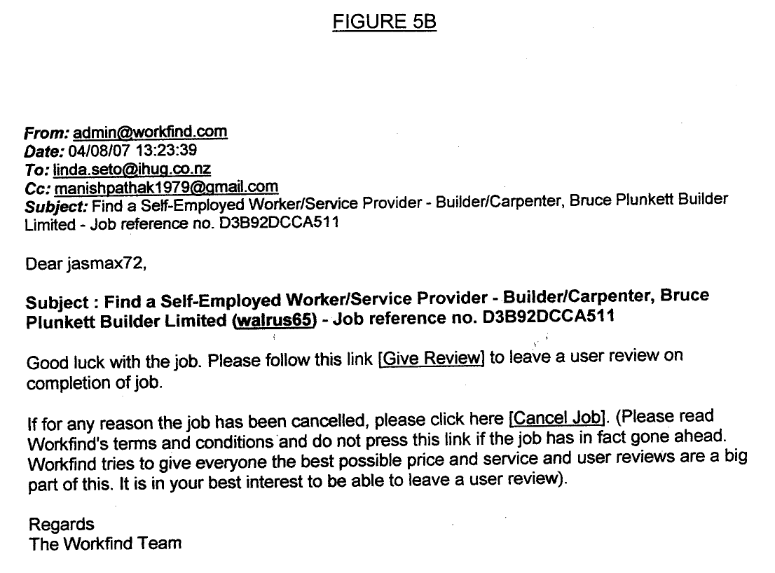

FIGS. 4, 5A and 5B show portions of a job request and job notification received and transmitted in accordance with a preferred embodiment.

As can be seen from FIG. 4 the user can be invited to enter job related information into a web page for subsequent collation and dispatch to the web portal provided in accordance with a preferred embodiment. The dispatched information may compose a job request to trigger the offering of a job to a particular service provider. In the instance shown a user is interested in employing the builder whose service provider listing is illustrated with respect to FIGS. 2 and 3. This user has previously contacted the builder and has agreed with them that they will perform a particular task. The user then returns to the web site portal provided and enters the information shown with respect to FIG. 4 to compile a job request.

As can be seen from FIG. 4, the information supplied can also include a cost indicator for the job involved. This cost indicator may be employed by the operator of the present invention to calculate a service charge or fee to be charged to the service provider who received the job in question. For example, in one embodiment, service providers may be charged a fee by the operator of the invention proportional to the value of the jobs they have received.

Portions of a job notification are illustrated with respect to FIGS. 5A and 5B. In the embodiment illustrated email transmissions may be made to both the service provider involved to confirm that they have received the job, and also to the user to confirm that they now have the ability to submit a service provider review once a task at hand has been completed.

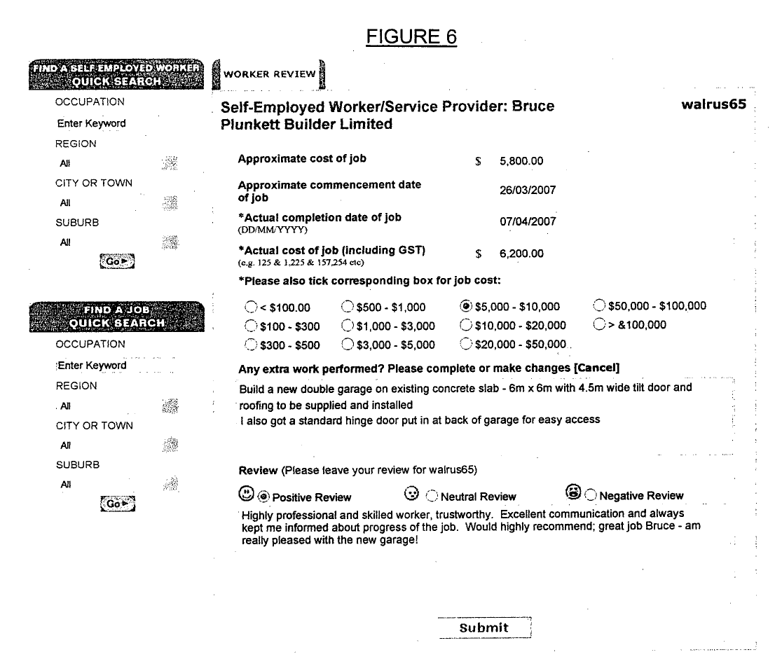

FIG. 6 shows a data entry page configured to collate and subsequently transmit a service provider review in a preferred embodiment.

The web page illustrated with respect to FIG. 6 prompts the user to enter feedback information used to formulate a service provider review. This information may be collated and dispatched to the internet portal web site and a subsequent email confirmation dispatched to the user confirming receipt of this review.

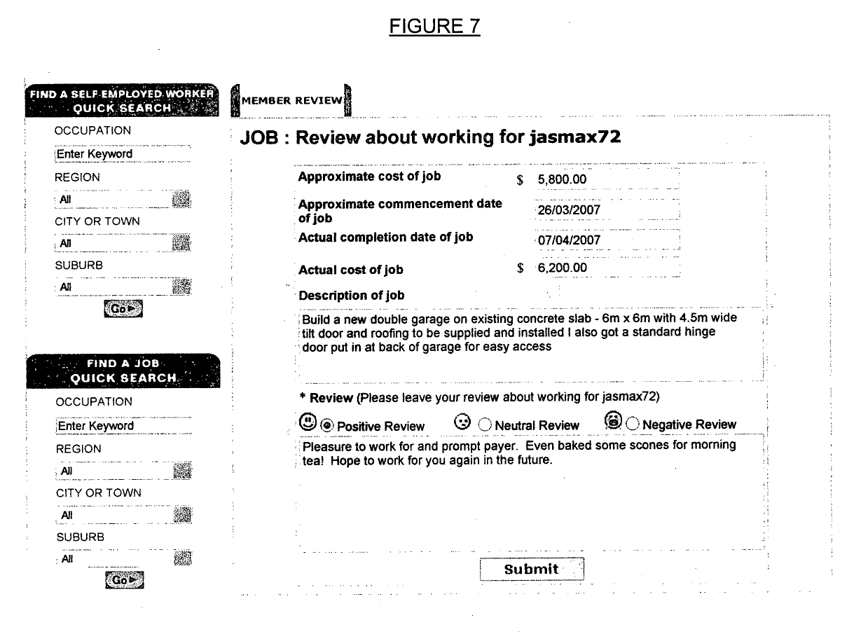

FIG. 7 shows a data entry page configured to collate and subsequently transmit a user review in a preferred embodiment.

The web page illustrated with respect to FIG. 7 allows a service provider to supply performance feedback information relating to a particular task they have performed for a user. This information may be collated and subsequently transmitted to the web site portal, and a further confirmation email may be dispatched to the service provider to confirm receipt of their user review.

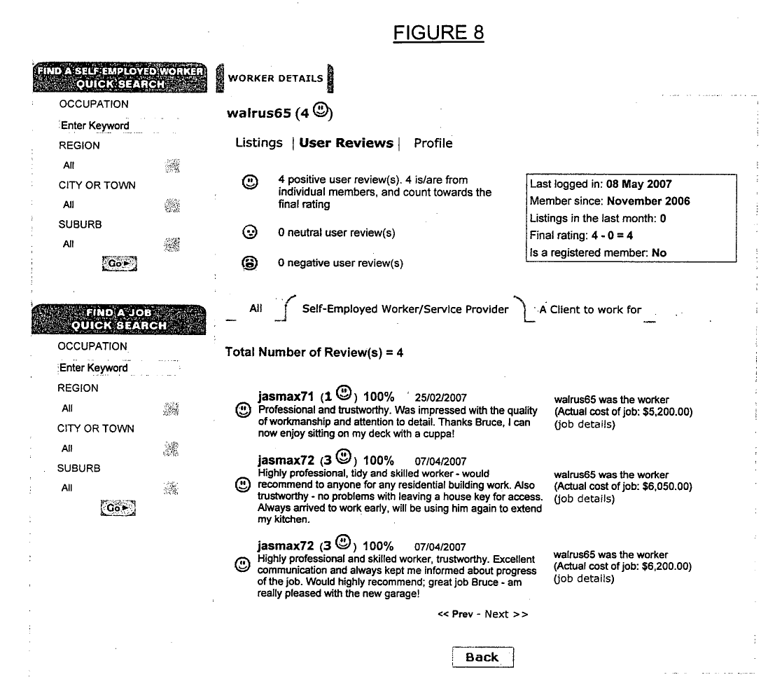

FIG. 8 shows portions of the updated service provider reviews illustrated with respect to FIG. 3 after a new service provider review has been received.

As can be seen from FIG. 8 a new user review has been received and subsequently integrated into the service provider listing for the builder discussed in the previous figures. This updated service provider listing now gives new feedback information with respect to the builder's recent performance which can be viewed by other users potentially looking to hire the builder service provider.

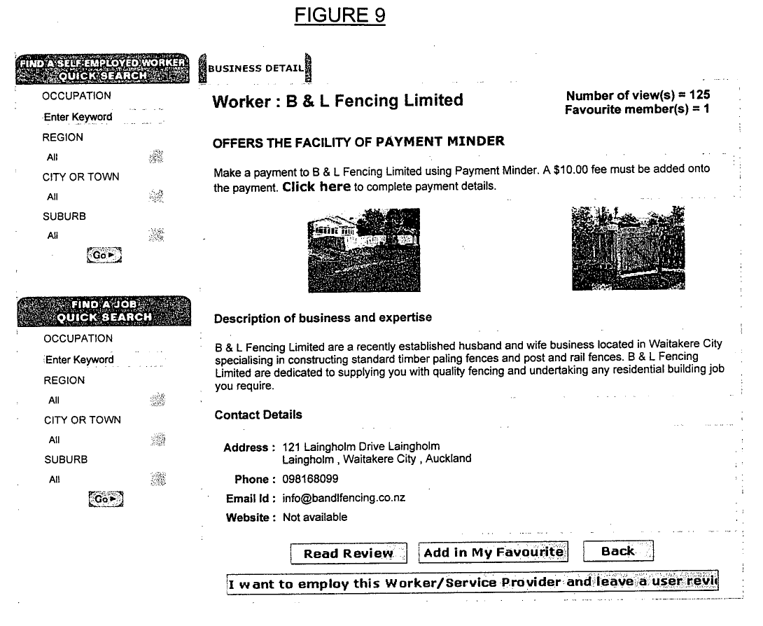

FIG. 9 shows a portion of a service provider listing wherein the service provider employs an escrow service or payment minder facility. This listing advises users that the service provider is a user of the escrow service (payment minder), through which payment may be made.

It should be appreciated that the present invention's notification of terms and conditions may be presented to users and service providers in a variety of formats such as via a link to a page displaying information on the use and conditions of the escrow service. The payment to be made can be negotiated directly with the service provider or may be an automatic proportion or the whole of the quotation provided for the job. These notifications may include a direct link to the escrow service (payment minder) for payment.

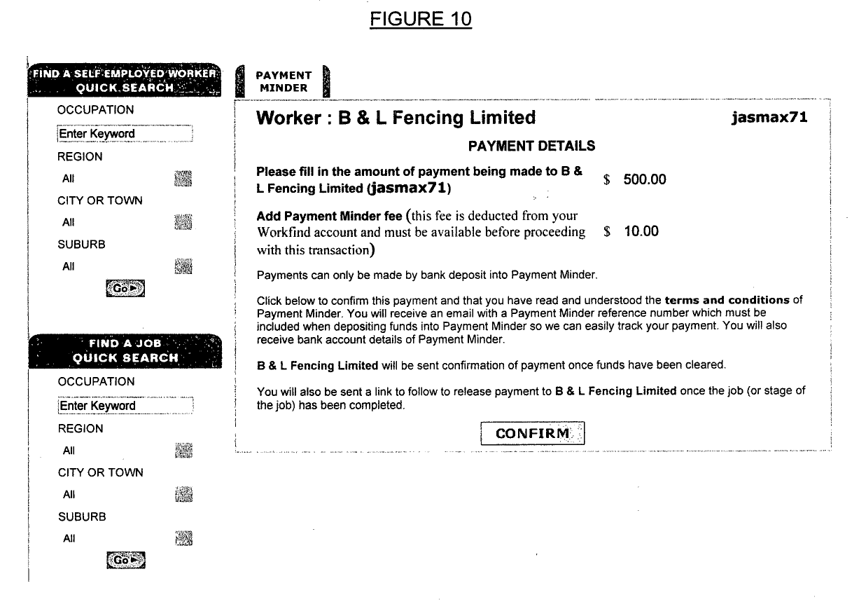

Once the service provider has provided a quote for the job the user may hire the service provider, and at the same time make payment into the escrow service. FIG. 10 shows a portion of a data entry form employed at this stage for the escrow service.

When the user submits the payment details a job reference number and account number to which the payment is to be deposited is next supplied to the user.

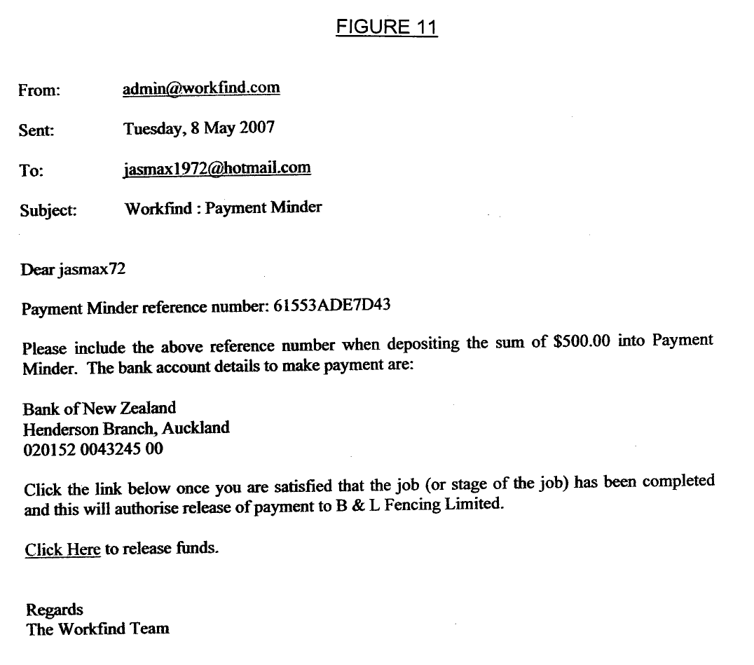

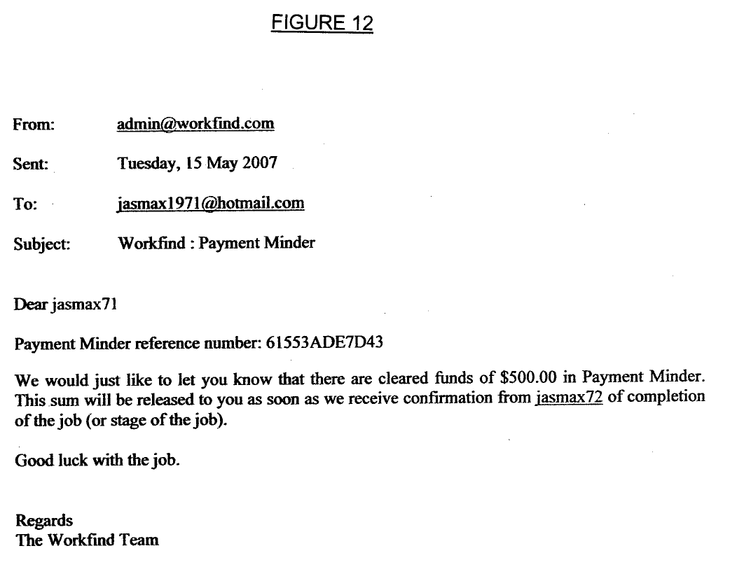

FIGS. 11 and 12 show alternative versions of a job request and job notification when an escrow service is employed in conjunction with a service provider.

As can be seen from the messages illustrated with respect to FIGS. 11 and 12, the user is provided with the information required to make such an escrow payment to allow the job to be started, and the service provider is advised that an escrow payment has been made and that funds have cleared to allow the job to be started.

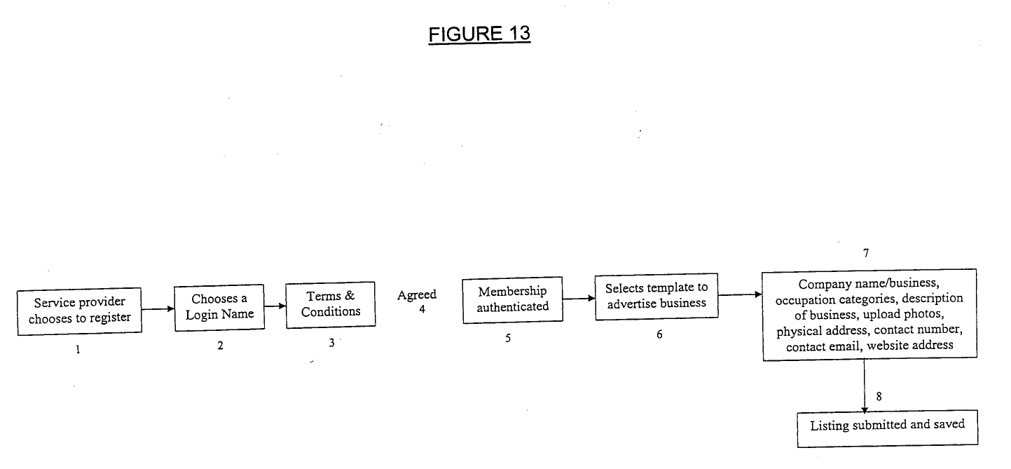

FIG. 13 illustrates how a service provider lists their details. Each of the steps employed in this process are discussed below.
1. An individual or business who is a tradesperson or service provider views the portal website and decide they would like to submit their details to advertise their skill or expertise so they choose to register.
2. They proceed to the Membership Joining page by clicking the Join for Free link on the homepage and choose a Login Name (which will be their User Display Name) and not necessarily their real name.
3 & 4 They must accept and agree to the Terms and Conditions to join the website.
5. They receive a confirmation email with their Login Name and Password and also a link to authenticate their membership and confirm their email address.
6. Once the member has authenticated their membership, they can then log into the website and access the page to fill in their service provider details.
7. The service provider completes all relevant fields and information necessary to advertise their particular trade or business.
8. Once the service provider has completed their business details, it is added to the website for anyone to view.

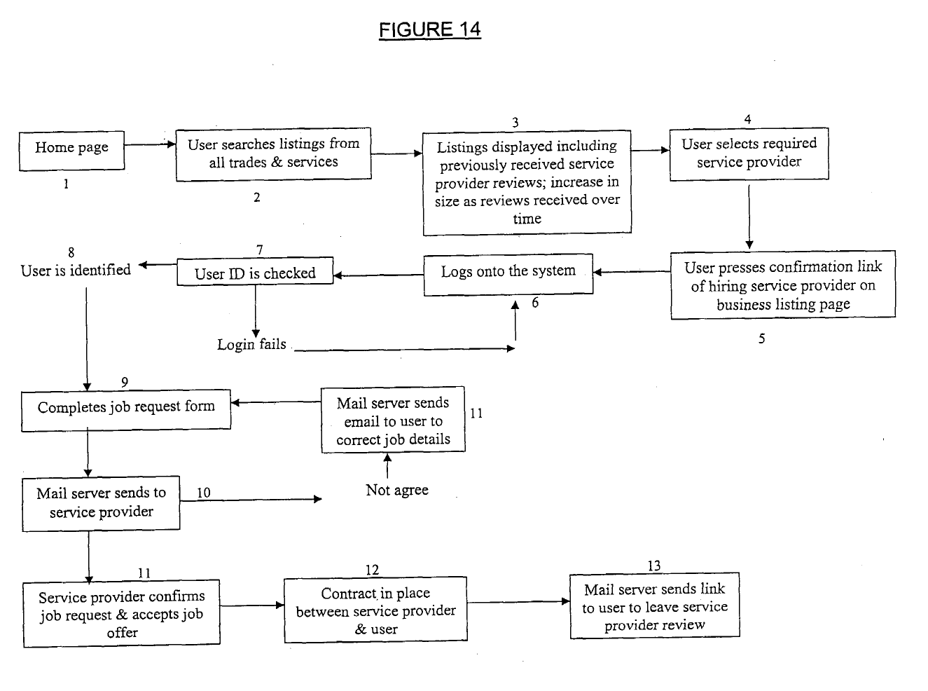

FIG. 14 illustrates how a user selects and employs a service provider. Each of the steps employed in this process are discussed below.
1. Anyone can view the homepage and browse the website.
2 & 3 They then search for the service provider they require e.g. builder or painter from all the different trades and services which generates a search results page with all the service provider listings relating to the particular trade or service which was searched. These individual service provider listings and all their related information can be further viewed by the user, including the service provider's previously received service provider reviews, which will increase in size as that service provider completes more jobs.
   The user can further refine their search of the particular trade or service by area i.e. Region, City or Town and Suburb.
4. After browsing through the service provider listings related to the trade or service they require, the user then chooses a preferred service provider who they would like to contact relating to a job required to be undertaken. They can then choose to contact the service provider directly through the service provider's details displayed on their listing.
5. If negotiations between the service provider and the user are mutually agreeable, the user may choose to employ the service provider. However, if the user decides to employ the service provider, they must press the confirmation link on the website of employing said service provider.
6. The user is then required to join the website in order to employ said service provider and to leave a user review about the service provider on completion of job. If the user is already a member, they can simply log in.
7 & 8 Once the user has logged in or become a General Member (free to join), their user ID is checked.
9. The user can then proceed to complete details about the job (Worker Booking form) which includes the approximate cost of job, approximate commencement date of job, approximate completion date of job and a brief description of the work for which they are getting the service provider to perform.
10. Once the job details are submitted, the mail server sends an email to the service provider for the service provider to either confirm the job details or to not agree to.
11. If the service provider does not agree to the job details, the mail server sends a request to the user to correct the job details. If the service provider agrees to the job details, the service provider clicks the CONFIRM JOB link provided in the email. They must do so within 7 days or else the job offer will lapse.
12 & 13 Once the service provider has accepted the job offer and confirmed the job details, a contract is in place between the service provider and user and an automatic email is sent to the user with confirmation of the accepted job and a link to either leave a user review after the job has been completed and a link in case of cancellation of the job.

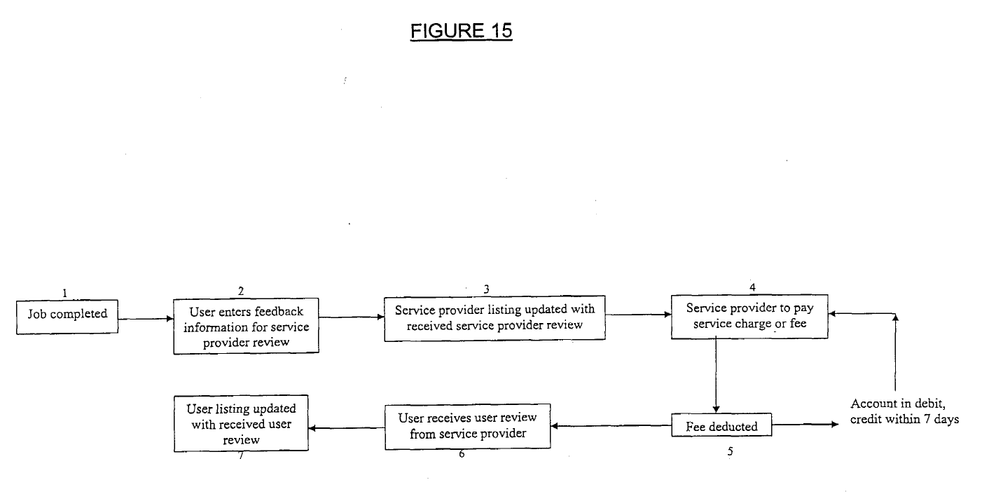

FIG. 15 illustrates how a service provider review and a user review are submitted. Each of the steps employed in this process are discussed below.
1. The service provider completes the job.
2. Once the job is completed, the user confirms the actual cost of the job and also leaves a review about the service provider who worked for them. This is done by the user either following the link sent to them in the email or by logging into the website and accessing the (leave review) link via their membership page.
3. Once the user has submitted a review about the service provider, the service provider listing is updated with the received service provider review.
4 & 5 Also, once the user has submitted a review about the service provider, the service provider then receives notification by email of their received review and of their Workfind fee payable (a small percentage of the actual total cost of job) which would have been automatically deducted from their Workfind account. If their account has gone into debit, the service provider must remedy within 7 days. In this notification email, the service provider is also sent a link so that they may leave a review about working for their client/customer i.e. the user.
6. The service provider leaves a review about working for the user.
7. The user listing is then updated with received user review.

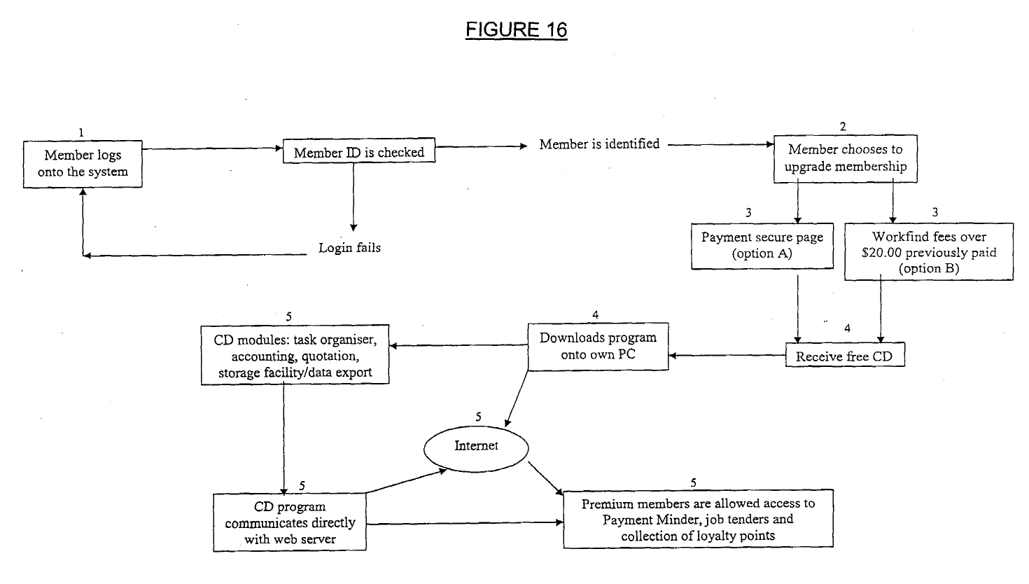

FIG. 16 illustrates how a registered user or member upgrades their membership. Each of the steps employed in this process are discussed below.
1. The member logs onto the system.
2. Member chooses to upgrade their membership by clicking the UPGRADE MEMBERSHIP link in their MY WORKFIND personal page.
3. Member chooses one of the following two options to upgrade membership:
   (A) Pay a $20.00 fee upfront which gives the member a future refund of $20.00 off their Workfind fees and receive instant Premium membership status;
   (B) If the member has previously paid over $20.00 worth of Workfind fees, then they receive instant Premium membership status for free.
   Member completes their address of where the CD should be posted to and clicks the SUBMIT button.
4. Member receives a free CD and downloads the program onto their own personal computer.
5. Member accesses the Workfind mainframe server with their downloaded program which transmits their new ID and Premium membership status. This gives the member who now has Premium membership status access to all the functions and features pertaining to this membership status. The new program on the personal computer is now able to receive information from the mainframe server about new jobs which the member has received and certain information will be automatically displayed in the program's features and functions. These functions include a task organiser, an accounting module, a quotations module and a storage/data export facility.
   Premium membership status also gives the service provider member the ability to offer their customers/clients the facility of Payment Minder, which is an escrow payment service offered by Workfind to Premium members.
   Other privileges of Premium membership status include the ability for service providers to participate in Workfind's loyalty points scheme by earning 3 loyalty points for every $10.00 paid in Workfind fees. Points collected are redeemable for gifts displayed on the website. Premium members may also place a Job Tender listing on the website, browse Job Tender listings on the website and submit a tender to carry out a job specified in a Job Tender listing. These privileges are not accessible to general members.

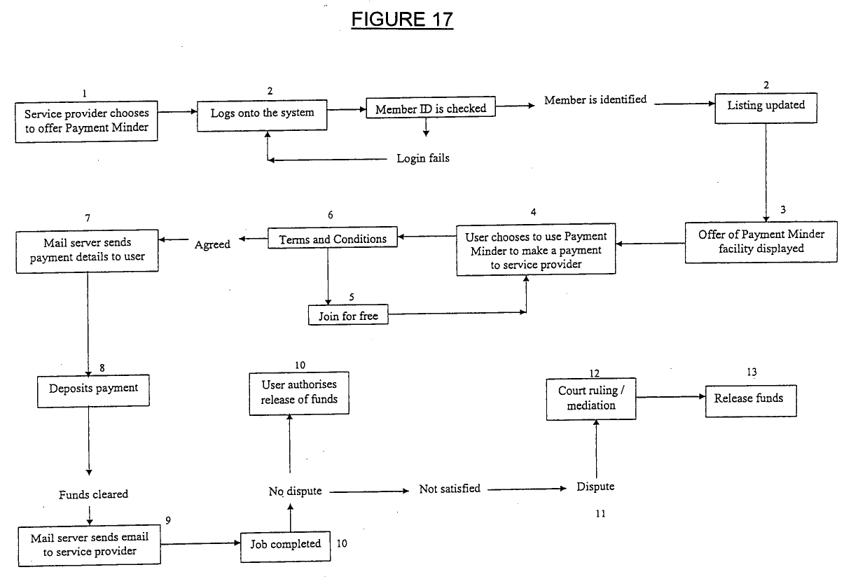

FIG. 17 illustrates use of Payment Minder facility (being an escrow service). Each of the steps employed in this process are discussed below.
1. The service provider has to become a Premium member in order to offer this facility to their customers/clients (the users).
2. Once a service provider has become a Premium member, they log onto the system and access their LISTINGS page through MY WORKFIND to update their listing to offer the escrow service of Payment Minder.
3. The offer of the Payment Minder facility is now displayed on the service provider's business detail page for anyone to view who browses their details.
4. A user browsing the website finds a suitable service provider, makes direct contact and decides they would like to employ the service provider to do a job. They then choose to make a payment to the service provider via the Payment Minder facility and clicks the appropriate link to complete payment details.
5. If the user is not a member, they are then prompted to become a member (free general membership) in order to use the facility.
6. The member completes details of the payment to be made and is advised of the $10.00 Workfind fee which will be automatically deducted from their Workfind account (before the transaction can proceed) and also agrees to the Terms and Conditions of Payment Minder before pressing the CONFIRM button.
7. The mail server sends an automatic email to the user with a reference number for the payment and appropriate bank account details to make payment into. The email also has a link which the user must click once the job has been completed to a satisfactory standard to release funds to the service provider.
8. The user deposits the funds into the Payment Minder account. Funds cannot be released before cleared.
9. When funds have cleared, the service provider receives an email notification from the mail server advising of funds being held in Payment Minder for them until the job has been completed satisfactorily.
10. The service provider completes the job and the satisfied user clicks the appropriate link from their email to release all of the funds or part of the funds (if both parties agree). If part funds are released, an automatic email is sent to the service provider for their confirmation of the agreed amount to be released.
11. The service provider completes the job and the unsatisfied user does not click either link to release the funds because there is a dispute in place.
12. The dispute goes to mediation or a Court hearing.
13. Payment Minder receives the appropriate documentation of Court ruling/mediation and releases the funds.

Aspects of the present invention have been described by way of example only and it should be appreciated that modifications and additions may be made thereto without departing from the scope thereof as defined in the appended claims.

What we claim is:

1. A computer-implemented method of promoting service providers, said method comprising the steps of:
i) publishing a plurality of service provider listings, each service provider listing including contact details of an associated service provider;
ii) publishing within each service provider listing reviews previously received for respective service providers;
iii) receiving a job contract offer identifying a user, one of said service providers, and a task to be completed the one service provider;
iv) receiving an acceptance notification;
v) forming, upon receiving said acceptance notification, a job contract between said user and said one service provider;
vi) receiving a further service provider review from the user upon completion of said job contract; and
vii) updating the service provider listing of the service provider associated with the further service provider review.

2. A method as claimed in claim 1, comprising the further steps of:
receiving a user review from the service provider associated with said job contract; and
updating a user listing of the user associated with said job contract.

3. A method as claimed in claim 1 or 2, wherein service provider listings list the services offered by respective service providers.

4. A method as claimed in claim 3, wherein one or more of said service provider listings also lists terms of employment offered by respective service providers.

5. A method as claimed in any one of claims 1 to 4 comprising the further step of:
transmitting an invoice to said service provider, the amount of said invoice being based upon the amount of said job contract.

6. A method as claimed in claim 5, comprising the further step of downloading one or more monetary values associated with said job contract to a program executing on a computer of said user or said service provider associated with said contract.

7. An apparatus for promoting service providers, said apparatus comprising:
i) means for presenting a plurality of service provider listings to a user;
iii) means for publishing within each service provider listing reviews previously received for respective service providers;
iii) means for receiving a job request from the user, said job request identifying a task to be completed and one of said service providers associated with the service provider listings;
iv) means for transmitting a job notification to the service provider identified in the job request, said job notification including at least said task to be completed;
v) means for forming, upon receiving an acceptance notification from said service provider identified in said job request, a job contract,
vi) means for receiving a further service provider review from the user upon completion of said job contract; and
vii) means for updating the service provider listing of the service provider associated with the further service provider review.

8. An apparatus as claimed in claim 7, comprising the further steps of:
means for receiving a user review from the service provider associated with said job contract; and
means for updating a user listing of the user associated with said job contract.

9. An apparatus as claimed in claim 7 or 8, wherein service provider listings list the services offered by respective service providers.

10. An apparatus as claimed in claim 9, wherein one or more of said service provider listings also lists terms of employment offered by respective service providers.

11. An apparatus as claimed in any one of claims 8 to 10 wherein said job request includes contact details of said user, allowing private negotiations.

12. An apparatus as claimed in any one of claims 8 to 11 comprising the further steps of:
means for transmitting an invoice to said service provider, the amount of said invoice being based upon the amount of said job contract.

13. A method of promoting service providers substantially as herein described with reference to and as illustrated by the accompanying drawings.

14. A service provider promotion apparatus substantially as herein described with reference to and as illustrated by the accompanying drawings.
